(19) United States
(12) Patent Application Publication
(10) Pub. No.: US 2014/0059494 A1
(43) Pub. Date: Feb. 27, 2014

(54) APPARATUS AND METHOD FOR PROVIDING APPLICATION LIST DEPENDING ON EXTERNAL DEVICE CONNECTED TO MOBILE DEVICE

(71) Applicant: Samsung Electronics Co., Ltd., Suwon-si (KR)

(72) Inventors: Chi-Hoon LEE, Seoul (KR); Sang-Hyuk KOH, Seoul (KR); Dong-Jun SHIN, Seoul (KR); Chul-Ho JANG, Seoul (KR); Eun-Sun KIM, Yongin-si (KR); Hwa-Young SONG, Seoul (KR); Hyung-Bo SIM, Gwangmyeong-si (KR); Yu-Jin LEE, Seoul (KR)

(73) Assignee: Samsung Electronics Co., Ltd., Suwon-si (KR)

(21) Appl. No.: 13/974,896

(22) Filed: Aug. 23, 2013

(30) Foreign Application Priority Data
Aug. 23, 2012 (KR) 10-2012-0092608

(51) Int. Cl. G06F 3/0482; G06F 3/0481

(52) U.S. Cl. CPC G06F 3/0482; G06F 3/04817
USPC 715/835

(57) ABSTRACT

A method for providing an application list depending on an external device connected to a mobile device is provided. The method includes displaying a plurality of first shortcut keys for executing a plurality of first applications, on a display of the mobile device, determining whether the mobile device is connected to an external device, if the mobile device is connected to the external device, displaying on the display at least one second shortcut key for executing at least one second application, with which the external device can be used, among the plurality of first applications, determining whether the second shortcut key displayed on the display is selected, if the second shortcut key is selected, executing a second application corresponding to the selected second shortcut key in the mobile device, and displaying execution results of the second application on the display.

### PRIORITY

This application claims the benefit under 35 U.S.C. §119(a) of a Korean patent application filed on Aug. 23, 2012 in the Korean Intellectual Property Office and assigned Serial No. 10-2012-0092608, the entire disclosure of which is hereby incorporated by reference.

### BACKGROUND OF THE INVENTION

1. Field of the Invention

The present invention relates to an apparatus and method for providing a list of applications available in a mobile device. More particularly, the present invention relates to an apparatus and method for providing a different application list depending on the external device connected to a mobile device.

2. Description of the Related Art

In recent years, there has been a dramatic increase in the diversity of services and add-ons provided by mobile devices. In order to increase the utility of these mobile devices and satisfy the various needs of users, a wide variety of applications, which can be executed in the mobile devices, have been developed.

Applications, which are stored and executed in the mobile devices, can be classified into default applications, which are developed by manufacturers of the devices and installed in the devices, and additional applications, which are downloaded from application sales websites on the Internet. The additional applications may be developed by general developers and registered in the application sales websites. Anyone who has developed applications may freely sell them to users of the mobile devices on the application sales websites. Accordingly, at present, tens to hundreds of thousands of free or paid applications are available to the mobile devices depending on the specifications of the devices.

Therefore, in recent years, at least several tens to hundreds of applications are stored in mobile devices such as smart phones and tablet Personal Computers (PCs), and shortcut keys for executing their associated applications are displayed on a touch screen of the mobile devices in the form of an icon. Accordingly, a user may execute a desired application in the mobile device by touching any one of the icons displayed on the touch screen.

However, even though these variety of applications stimulating the curiosity and meeting the needs of the consumers are provided to mobile devices, other unexpected problems may occur due to the increase in the number of applications executable in the mobile devices. Specifically, a large number of applications are stored in mobile devices, and the number of icons displayable on a screen with a size of about 4 to 10 inches, which is mounted on the mobile devices, is very limited. Thus, a user needs to inconveniently search through a list of applications to find the desired application among the numerous applications, which requires a lot of time. In addition, a user who is not familiar with the use of the mobile devices may not know which applications he or she can use or enjoy with external devices such as earphones, media players, cradles, and the like when the external devices are connected to the mobile devices. In the worst case, the user may not find his or her desired applications from among the numerous applications.

Accordingly, there is a need for an apparatus and method for quickly finding shortcut keys for executing applications which can be used in the mobile device.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and method in which, when an external device is connected to a mobile device, a user may quickly find shortcut keys for executing applications which can be used in the mobile device using the connected external device.

Another aspect of the present invention is to provide an apparatus and method for providing a list of customized applications, which are frequently used by a user, depending on the user's usage pattern, if an external device is connected to a mobile device.

Yet another aspect of the present invention is to provide an apparatus and method for providing a list of customized applications, which are frequently used by a user, depending on the user's location, if an external device is connected to a mobile device.

At least one of the foregoing aspects of the present invention may be achieved as described below.

In accordance with an aspect of the present invention, a method for providing an application list depending on an external device connected to a mobile device is provided. The method includes displaying a plurality of first shortcut keys, for executing a plurality of first applications, on a display of the mobile device, determining whether the mobile device is connected to an external device, if the mobile device is connected to the external device, displaying on the display at least one second shortcut key for executing at least one second application, with which the external device can be used, among the plurality of first applications, determining whether the second shortcut key displayed on the display is selected, if the second shortcut key is selected, executing a second application corresponding to the selected second shortcut key in the mobile device, and displaying execution results of the second application on the display.

The at least one second shortcut key may be selected from the plurality of first shortcut keys, and the number of the at least one second shortcut key may be less than the number of the plurality of first shortcut keys.

The at least one second shortcut key may be selected from the plurality of first shortcut keys based on information about at least one of the number of executions, the execution time and the execution order of the plurality of first applications, which have been executed while the external device is connected to the mobile device.

The at least one second shortcut key may be selected from the plurality of first shortcut keys, and may include different first shortcut keys which are selected depending on at least one of the current location of the mobile device and the current time.

The external device may be an earphone that is connected to an earphone connecting jack of the mobile device, and the second shortcut key may be displayed on the display to slide along a direction in which the earphone is inserted into the earphone connecting jack.

The external device may include an external device connector that is connected to a connector of the mobile device, and the second shortcut key may be displayed on the display to slide along a direction in which the external device connector is inserted into the connector of the mobile device.

The second shortcut key may disappear from the display to slide along a direction in which the external device is detached from the mobile device.

The external device may be wirelessly connected to the mobile device by wireless short-range communication.

The at least one second shortcut key may be displayed on a lock screen of the mobile device.

At least some of the at least one second application may be downloaded in the mobile device from an application sales website on the Internet.

In accordance with another aspect of the present invention, an apparatus for providing an application list depending on an external device connected to a mobile device is provided. The apparatus includes a display for displaying a plurality of first shortcut keys for executing a plurality of first applications, an external device connector to which an external device is connected by wire or wirelessly, and a controller for displaying on the display at least one second shortcut key for executing at least one second application, with which the external device can be used, among the plurality of first applications, if the external device is connected to the external device connector.

If no second shortcut key displayed on the display is selected, the controller may display again on the display the plurality of first shortcut keys for executing the plurality of first applications.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic block diagram illustrating a mobile device according to an exemplary embodiment of the present invention;

FIG. 2 is a front perspective view of a mobile device according to an exemplary embodiment of the present invention;

FIG. 3 is a rear perspective view of a mobile device according to an exemplary embodiment of the present invention;

FIGS. 4A to 4E illustrate a menu screen displayed on a mobile device according to an exemplary embodiment of the present invention;

FIG. 5 is a schematic flowchart illustrating a method for providing a list of customized applications depending on the external device connected to a mobile device according to an exemplary embodiment of the present invention;

FIG. 6 illustrates a list of customized applications displayed on a display according to an exemplary embodiment of the present invention;

FIG. 7 is a schematic flowchart illustrating a method for providing a list of customized applications depending on the external device connected to a mobile device according to an exemplary embodiment of the present invention;

FIG. 8 illustrates a recommendation order of applications depending on the external device connected to a mobile device according to an exemplary embodiment of the present invention;

FIG. 9 is a schematic flowchart illustrating a method for providing a list of customized applications depending on the external device connected to a mobile device according to an exemplary embodiment of the present invention;

FIGS. 10A to 10C illustrate a list of customized applications displayed on a display according to an exemplary embodiment of the present invention;

FIGS. 11A to 11C illustrate a list of customized applications disappearing from a display according to an exemplary embodiment of the present invention;

FIGS. 12A to 12C illustrate a list of customized applications displayed on a display according to an exemplary embodiment of the present invention;

FIGS. 13A to 13C illustrate a list of customized applications disappearing from a display according to an exemplary embodiment of the present invention;

FIG. 14 illustrates a mobile device connected to a multimedia player according to an exemplary embodiment of the present invention;

FIG. 15 illustrates a mobile device connected to a car navigation device according to an exemplary embodiment of the present invention; and

FIG. 16 illustrates a mobile device connected to a game manipulation device according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Descriptions of some well-known technologies that possibly obscure exemplary embodiments of the present invention will be omitted, if necessary.

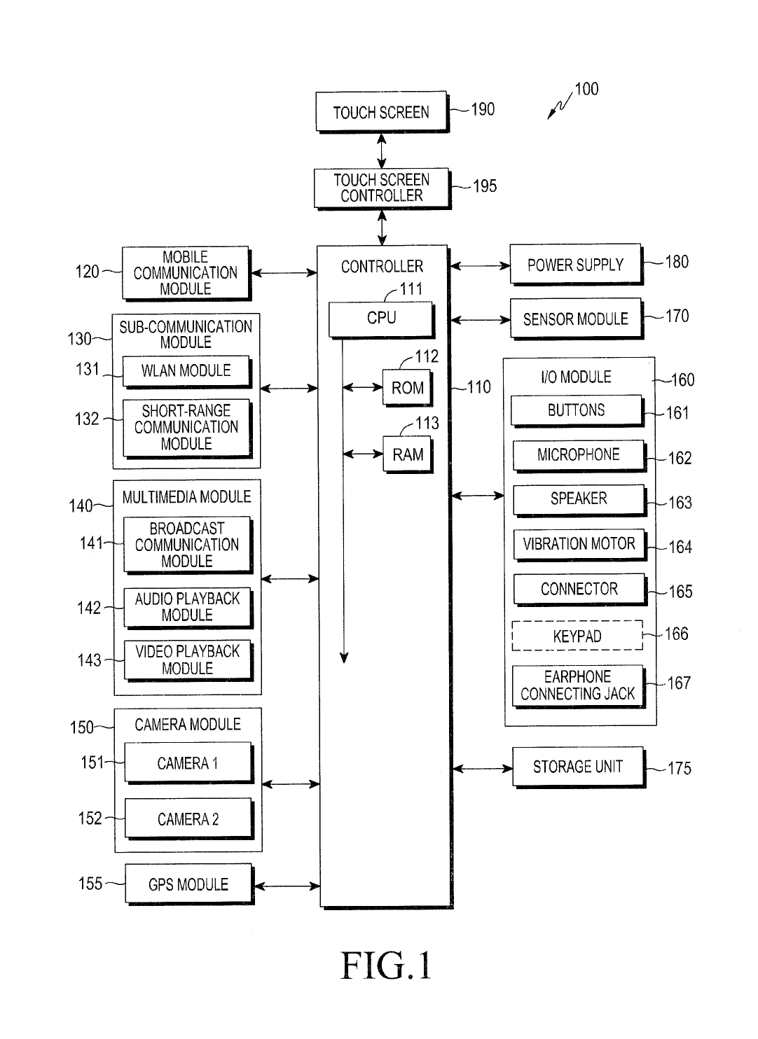

FIG. 1 is a schematic block diagram illustrating a mobile device according to an exemplary embodiment of the present invention.

Referring to FIG. 1, a device 100 may be connected to external devices (not shown) through external device connection units such as a sub-communication module 130, a connector 165 and an earphone connecting jack 167. The ‘external devices’ may include a variety of devices which can be attached and detached to/from the device 100 by wire, such as earphones, external speakers, Universal Serial Bus (USB) memories, chargers, cradles/docks, Digital Multimedia Broadcasting (DMB) antennas, mobile payment-related devices, healthcare devices (for example, glucose meters), game consoles, car navigation devices, and the like. In addition, the ‘external devices’ may include short-range communication devices (for example, Bluetooth communication devices, and Near Field Communication (NFC) devices), which can be wirelessly connected to the device 100 by short-range communication, and may also include WiFi Direct communication devices, and wireless Access Points (APs). Further, the external devices may other devices, cell phones, smart phones, tablet PCs, desktop PCs, and servers.

Referring to FIG. 1, the device 100 may include a display 190 and a display controller 195. In addition, the device 100 includes a controller 110, a mobile communication module 120, the sub-communication module 130, a multimedia module 140, a camera module 150, a Global Positioning System (GPS) module 155, an Input/Output (I/O) module 160, a sensor module 170, a storage unit 175, and a power supply 180. The sub-communication module 130 includes at least one of a Wireless Local Area Network (WLAN) module 131 and a short-range communication module 132, and the multimedia module 140 includes at least one of a broadcast communication module 141, an audio playback module 142, and a video playback module 143. The camera module 150 includes at least one of a first camera 151 and a second camera 152, and the I/O module 160 includes at least one of buttons 161, a microphone 162, a speaker 163, a vibration motor 164, the connector 165, and a keypad 166. It will be assumed herein that the display 190 and the display controller 195 are a touch screen and a touch screen controller, respectively.

The controller 110 may include a Central Processing Unit (CPU) 111, a Read Only Memory (ROM) 112 storing control programs for control of the device 100, and a Random Access Memory (RAM) 113 used as a memory area for storing externally received signals or data or from performing operations in the device 100. The CPU 111 may include a single-core CPU, a dual-code CPU, a triple-core CPU or a quad-core CPU. The CPU 111, the ROM 112 and the RAM 113 may be interconnected via an internal bus.

The controller 110 controls the mobile communication module 120, the sub-communication module 130, the multimedia module 140, the camera module 150, the GPS module 155, the I/O module 160, the sensor module 170, the storage unit 175, the power supply 180, the touch screen 190, and the touch screen controller 195.

The mobile communication module 120, under control of the controller 110, connects the device 100 to the external devices by mobile communication using at least one or multiple antennas (not shown). The mobile communication module 120 exchanges wireless signals for voice calls, video calls, Short Message Service (SMS) messages or Multimedia Messaging Service (MMS) messages, with cell phones (not shown), smart phones (not shown), tablet PCs (not shown) and other devices (not shown), whose phone numbers are entered in the device 100.

The sub-communication module 130 may include at least one of the WLAN module 131 and the short-range communication module 132. For example, the sub-communication module 130 may include any one or both of the WLAN module 131 and the short-range communication module 132.

The WLAN module 131, under control of the controller 110, may access the Internet in places where no wireless AP (not shown) is installed. The WLAN module 131 supports the WLAN standard IEEE802.11x of the Institute of Electrical and Electronics Engineers (IEEE). The short-range communication module 132 may perform wireless short-range communication between the device 100 and image forming devices (not shown), under control of the controller 110. The short-range communication may include Bluetooth, Infrared Data Association (IrDA), WiFi Direct, NFC, and the like.

The device 100 may include at least one of the mobile communication module 120, the WLAN module 131, and the short-range communication module 132, depending on its performance. For example, the device 100 may include a combination of the mobile communication module 120, the WLAN module 131, and the short-range communication module 132, depending on its performance.

The multimedia module 140 may include the broadcast communication module 141, the audio playback module 142, or the video playback module 143. The broadcast communication module 141, under control of the controller 110, may receive broadcast signals (for example, TV broadcast signals, radio broadcast signals or data broadcast signals) and additional broadcast information (for example, Electric Program Guide (EPG) or Electric Service Guide (ESG)), which are transmitted from broadcasting stations via a broadcast communication antenna (not shown). The audio playback module 142, under control of the controller 110, may play the stored or received digital audio files (with a file extension of, for example, mp3, wma, ogg or way). The video playback module 143, under control of the controller 110, may play the stored or received digital video files (with a file extension of, for example, mpeg, mpg, mp4, avi, mov, or mkv). The video playback module 143 may also play the digital audio files.

The multimedia module 140 may include only the audio playback module 142 and the video playback module 143, excluding the broadcast communication module 141. The audio playback module 142 and the video playback module 143 in the multimedia module 140 may also be incorporated into the controller 110.

The camera module 150 may include at least one of the first and second cameras 151 and 152, which may capture still or video images under control of the controller 110. One of the first and second cameras 151 and 152 may include a secondary light source (for example, a flash) for providing the light necessary for capturing or shooting. The first camera 151 may be mounted on the front of the device 100, while the second camera 152 may be mounted on the rear of the device 100. In an alternative option, the first and second cameras 151 and 152 may be mounted adjacent to each other with a gap of, for example, 1 to 8 cm, to capture three-dimensional (3D) still or video images.

The GPS module 155 may receive radio waves from a plurality of GPS satellites (not shown) in the Earth orbit, and calculate the location of the device 100 using the Time of Arrival (ToA) from the GPS satellites to the device 100.

The I/O module 160 may include at least one of the buttons 161, the microphone 162, the speaker 163, the vibration motor 164, the connector 165, and the keypad 166.

The buttons 161 may be formed on the front, side or rear of the housing of the device 100, and may include at least one of a power/lock button (not shown), a volume button (not shown), a menu button, a home button, a back button, and a search button.

The microphone 162 generates electrical audio signals by receiving voices or sounds, under control of the controller 110.

The speaker 163, under control of the controller 110, may output sounds corresponding to a variety of signals (for example, wireless signals, broadcast signals, digital audio files, digital video files, photo-shooting signals or the like) from the mobile communication module 120, the sub-communication module 130, the multimedia module 140 or the camera module 150, to the outside of the device 100. The speaker 163 may output the sounds (for example, button manipulation tones for phone calls, or ring-back tones) corresponding to the features of the device 100. One or multiple speakers 163 may be formed in a proper position or positions of the housing of the device 100.

The vibration motor 164 may convert electrical signals into mechanical vibrations under control of the controller 110. For example, upon receiving a voice call from another device (not shown), the device 100 in a vibration mode activates or enables the vibration motor 164. One or multiple vibration motors 164 may be formed in the housing of the device 100. The vibration motor 164 may operate in response to a user's touch action occurring on the touch screen 190, and a continuous movement of a touch on the touch screen 190.

The connector 165 may be used as an interface for connecting the device 100 to the external devices (not shown) or power sources (not shown). The device 100, under control of the controller 110, may transmit the data stored in the storage unit 175 of the device 100 to the external devices (not shown), or receive data from the external devices (not shown), through a wired cable connected to the connector 165. In addition, the device 100 may receive power from a power source (not shown) or charge its rechargeable battery (not shown) with the power source, through the wired cable connected to the connector 165.

The keypad 166 may receive key inputs from the user, for control of the device 100. The keypad 166 includes a physical keypad (not shown) formed on the device 100, or a virtual keypad (not shown) displayed on the touch screen 190. The physical keypad formed on the device 100 is optional depending on the performance or structure of the device 100.

Into the earphone connecting jack 167 may be inserted an earphone (not shown) and connected to the device 100.

The sensor module 170 includes at least one sensor for detecting the status of the device 100. For example, the sensor module 170 may include a proximity sensor (not shown) for detecting whether the user is close to the device 100, an illuminance sensor (not shown) for detecting the amount of light around the device 100, a motion sensor (not shown) for detecting motion (for example, rotation, acceleration or vibration) of the device 100, a geo-magnetic sensor (not shown) for detecting the point-of-compass using the Earth's magnetic field, a gravity sensor for detecting the direction of gravity, and an altimeter for detecting the altitude, for example by measuring the pressure of the atmosphere. At least one sensor may detect the status of the device 100, generate a signal corresponding to the detection, and transfer the generated signal to the controller 110. Sensors may be added or removed to/from the sensor module 170 depending on the performance of the device 100.

The storage unit 175, under control of the controller 110, may store the signals or data, which are input and output to correspond to operations of the mobile communication module 120, the sub-communication module 130, the multimedia module 140, the camera module 150, the GPS module 155, the I/O module 160, the sensor module 170, and the touch screen 190. The storage unit 175 may store control programs for control of the device 100 or the controller 110, and a variety of applications.

The term ‘storage unit’ may be construed to include the storage unit 175, the ROM 112 and RAM 113 in the controller 110, or a memory card (not shown; for example, a Secure Digital (SD) card, a memory stick, etc.) mounted in the device 100. The storage unit may include non-volatile memories, volatile memories, Hard Disk Drives (HDDs), or Solid State Drives (SSDs).

The power supply 180, under control of the controller 110, may supply power to one or multiple rechargeable batteries (not shown) mounted in the housing of the device 100. One of multiple batteries may supply power to the device 100. The power supply 180 may also supply power to the device 100, which is received from an external power source (not shown) through a wired cable connected to the connector 165. The power supply 180 may also supply power to the device 100, which is wirelessly received from the external power source by wireless charging technology.

The touch screen 190 may provide User Interfaces (UIs) corresponding to a variety of services (for example, calls, data transmission, broadcasting, photo shooting, etc.), to the user. The touch screen 190 may transfer analog signals corresponding to at least one touch entered on the UI, to the touch screen controller 195. The touch screen 190 may receive at least one touch input by means of the user's body (for example, fingers including the thumb) or a touch input means (for example, a stylus pen). The touch input 190 may also receive a continuous movement of a touch among at least one touch. The touch screen 190 may transfer analog signals corresponding to the continuous movement of a touch input, to the touch screen controller 195.

In exemplary embodiments of the present invention, the term ‘touch’ is not limited to the contact touch with the touch screen 190 by the user's body or the touch input means, but may also include a contactless touch with the touch screen 190 by the user's body or touch input means, with a detectable gap of, for example, 1 mm or less. The gap detectable in the touch screen 190 may vary depending on the performance or structure of the device 100.

The touch screen 190 may be implemented in, for example, a resistive type, a capacitive type, an infrared type, or an acoustic wave type.

The touch screen controller 195 converts analog signals received from the touch screen 190 into digital signals (for example, X/Y coordinates), and transfers the digital signals to the controller 110. The controller 110 may control the touch screen 190 using the digital signals received from the touch screen controller 195. For example, the controller 110 may select or execute a shortcut icon (not shown) displayed on the touch screen 190 in response to a touch. The touch screen controller 195 may also be incorporated into the controller 110.

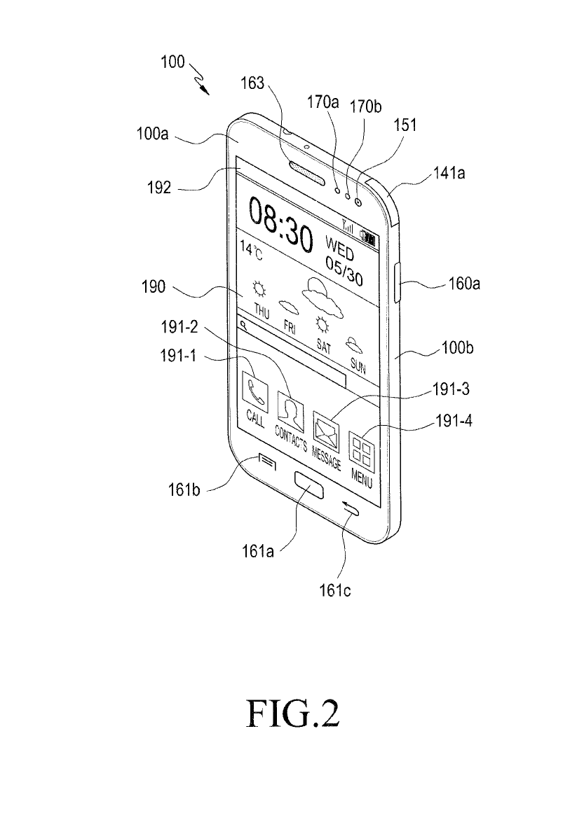

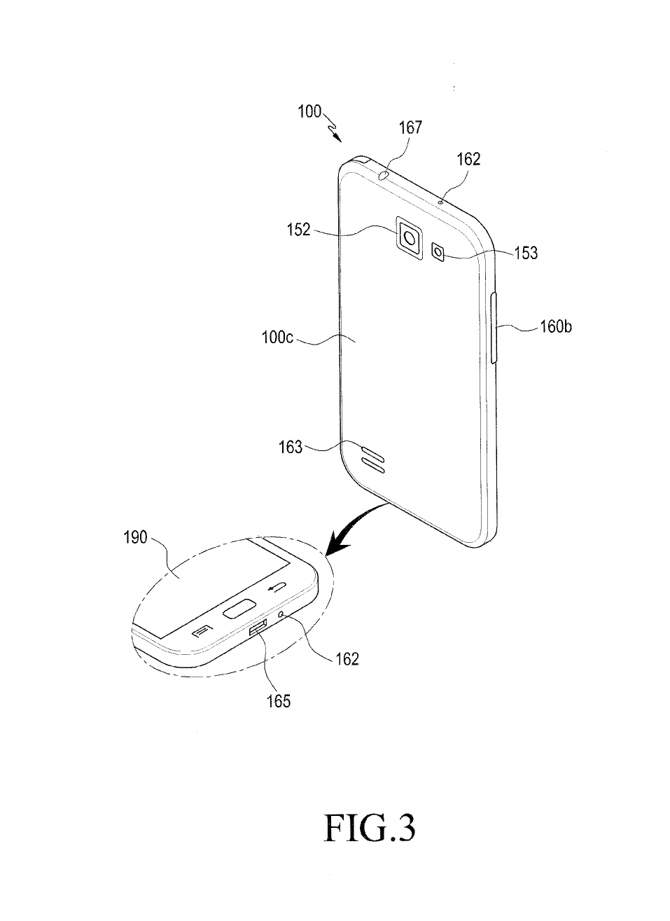

FIG. 2 is a front perspective view of a mobile device according to an exemplary embodiment of the present invention, and FIG. 3 is a rear perspective view of a mobile device according to an exemplary embodiment of the present invention.

Referring to FIGS. 2 and 3, a touch screen 190 is mounted on the center of a front 100a of a device 100. The touch screen 190 is formed so as to occupy most of the front 100a of the device 100. In the example of FIG. 2, a main home screen is displayed on the touch screen 190. The main home screen is the first screen that is displayed on the touch screen 190 upon power-up of the device 100. If the device 100 has different home screens of several pages, the main home screen may be the first home screen among the home screens of several pages. On the home screen may be displayed shortcut icons 191-1, 191-2 and 191-3 for executing the frequently used applications, a main menu switch key 191-4, time, weather, and the like. The main menu switch key 191-4 is used to display a menu screen on the touch screen 190. At the top of the touch screen 190 may be formed a status bar 192 which shows the status of the device 100, such as battery level, received signal strength, the current time, and the like.

Under the touch screen 190 may be formed a home button 161a, a menu button 161b and a back button 161c.

The home button 161a is used to display the main home screen on the display 190. For example, if the home button 161a is touched while any home screen different from the main home screen or a menu screen is being displayed on the touch screen 190, the main home screen may be displayed again on the touch screen 190. If the home button 161a is touched while applications are being executed on the touch screen 190, the main home screen shown in FIG. 2 may be displayed again on the touch screen 190. The home button 161a may also be used to display the recently display applications on the touch screen 190, or to display a task manager.

The menu button 161b is used to provide connection menus that can be used on the touch screen 190. The connection menus may include a widget add menu, a wallpaper change menu, a search menu, an edit menu, a preference menu, and the like.

The back button 161c may be used to display a screen which was displayed before the current screen, or to terminate the currently used application.

On the edge of the front 100a of the device 100 may be mounted a first camera 151, an illuminance sensor 170a, and a proximity sensor 170b. On a rear 100c of the display 100 may be mounted a second camera 152, a flash 153 and a speaker 163.

On a side 100b of the device 100 may be mounted, for example, a power/reset button 160a, a volume button 160b, a terrestrial DMB antenna 141a for broadcast reception, and one or multiple microphones 162. The DMB antenna 141a may be formed to be fixed to the device 100, or to be detachable from the device 100.

A connector 165 is formed in the bottom side of the device 100. Multiple electrodes are formed in the connector 165, and they may be connected to the external devices by wire. An earphone connecting jack 167 may be formed in the top side of the device 100. An earphone may be inserted into the earphone connecting jack 167.

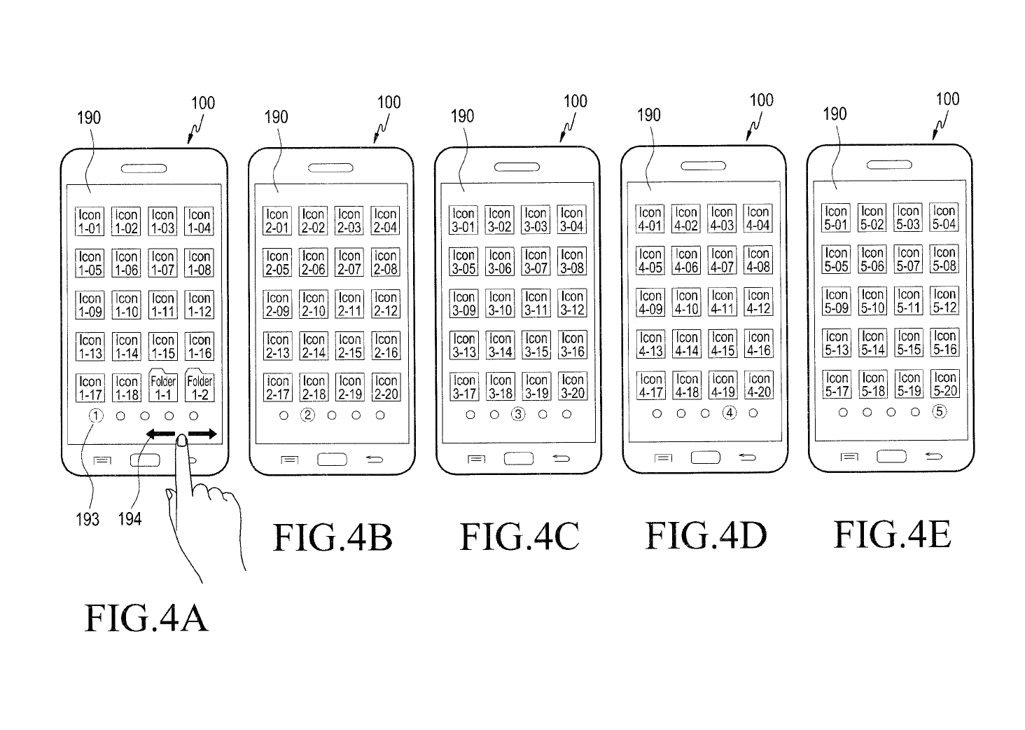

FIGS. 4A to 4E illustrate a menu screen displayed on a mobile device according to an exemplary embodiment of the present invention.

FIGS. 4A to 4E illustrate menu screens displayed on a touch screen 190. First shortcut keys for executing first applications available in the device 100, and folders may be arranged and displayed on the menu screens in the form of a matrix of rows and columns. One or more first shortcut keys may be included in each of the folders. Each of the first applications may be displayed on the menu screen in the form of a widget. The first applications include the applications which are stored in the device 100 by the manufacturer of the device 100. The first applications may also include the applications that the user has downloaded in the device 100 from the application sales websites on the Internet after purchasing the device 100. The first shortcut keys may be formed as icons or buttons which are comprised of images, texts, photos, or a combination thereof. In the examples of FIGS. 4A to 4E, the menu screens are formed to be different from the main home screen in FIG. 2. In this case, the menu screens and the home screens may be formed differently. On the other hand, the menu screens may be used as home screens. In this case, either the menu screens or the home screens may not exist in the device 100.

Referring to FIGS. 4A to 4E, the exemplary menu screens include a total of 5 pages. Each page includes 20 first shortcut keys, which may be formed as icons. For example, FIG. 4A illustrates a first page of a menu screen, and the first page includes 18 first icons Icon 1-01˜Icon 1-18 and 2 folders Folder 1-1 and Folder 1-2. The first page of the menu screen may be a main menu screen. A page indicator 193 is displayed on the bottom of the touch screen 190 in FIG. 4A, and indicates that the first page among the menu screens is currently displayed on the touch screen 190. In FIG. 4B, a second page among the menu screens is displayed on the touch screen 190, and the second page includes 20 first icons Icon 2-01˜Icon 2-20. In FIG. 4C, a third page among the menu screens is displayed on the touch screen 190, and the third page includes 20 first icons Icon 3-01˜Icon 3-20. In FIG. 4D, a fourth page among the menu screens is displayed on the touch screen 190, and the fourth page includes 20 first icons Icon 4-01˜Icon 4-20. In FIG. 4E, a fifth page among the menu screens is displayed on the touch screen 190, and the fifth page includes 20 first icons Icon 5-01˜Icon 5-20. The user may switch the pages of the menu screens displayed on the touch screen 190 by making a flicking or drag gesture to the left or the right on the touch screen 190 in the direction of an arrow 194 as illustrated in FIG. 4A. If any one of the icons is touched, the controller 110 executes an application corresponding to the touched icon and displays the application on the touch screen 190.

In recent years, at least tens to hundreds of applications are stored in the mobile device 100 such as a smart phone and a tablet PC. Therefore, in order to execute a specific application in the device 100, the user needs to find his or her desired application among the numerous applications by flipping pages of the menu screens shown in FIGS. 4A to 4E, spending a lot of time on the search. In addition, a user who is not familiar with the device 100 may not know which applications he or she can use or enjoy with external devices such as earphones, media players, cradles, and the like when the external devices are connected to the device 100. Therefore, according to exemplary embodiments of the present invention, as described below, if an external device is connected to the device 100, the user may quickly find a shortcut key or shortcut icon for executing an application that can be used in the device 100 using the connected external device.

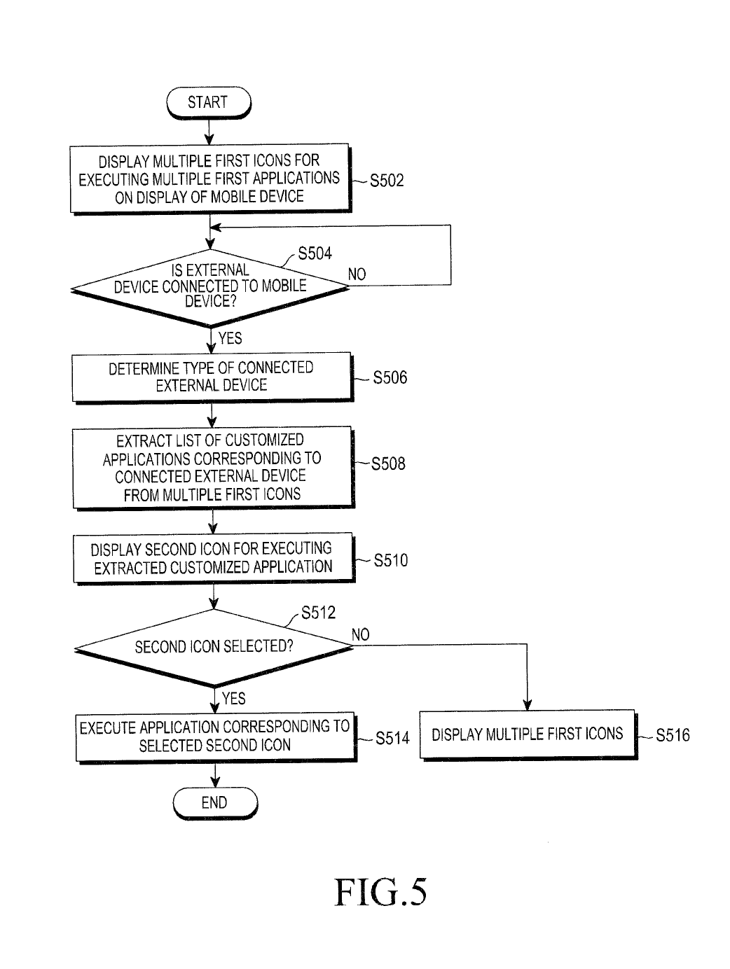

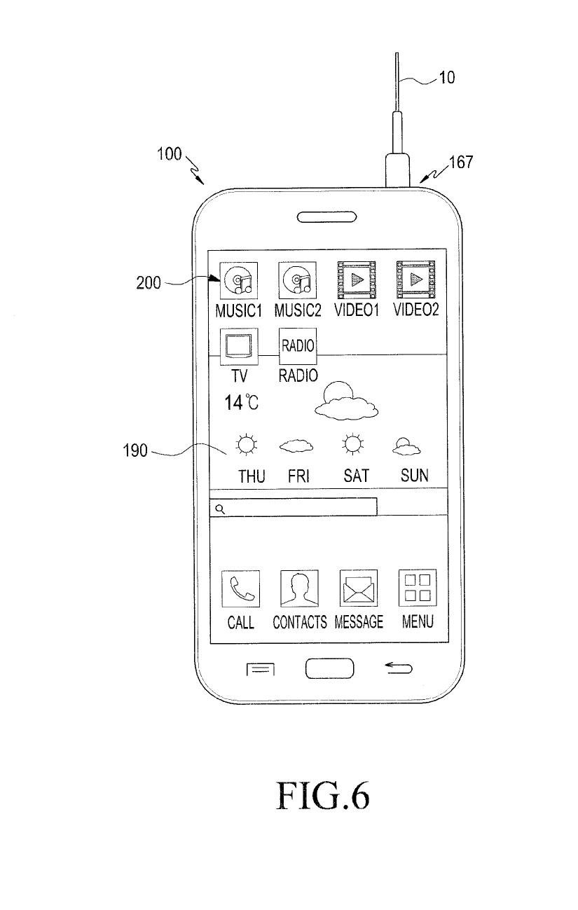

FIG. 5 is a schematic flowchart illustrating a method for providing a list of customized applications depending on the external device connected to a mobile device according to an exemplary embodiment of the present invention and FIG. 6 illustrates a list of customized applications displayed on a display according to an exemplary embodiment of the present invention.

Referring to FIG. 5, the controller 110 displays a plurality of first shortcut keys for executing a plurality of first applications on the touch screen 190 in step S502. The plurality of first applications, which are applications executable in the device 100, may be stored in the device 100 or may be downloaded in the device 100 from an external application web server(s). The first shortcut keys may be formed as icons and displayed on the touch screen 190, as illustrated in FIGS. 4A to 4E.

Subsequently, the controller 110 determines in step S504 whether an external device is connected to the device 100. If an external device is connected to the device 100, the controller 110 determines a type of the connected external device in step S506. Although steps S504 and S506 are separately described for convenience of description, the controller 110 may recognize steps S504 and S506 as one operation. For example, if an external device is connected to electrodes formed in the device 100 by being inserted into the earphone connecting jack 167 or the connector 165 of the device 100, the controller 110 may determine that the external device is connected to the device 100 by wire. Also, if the device 100 is wirelessly connected to the external device by WLAN, Bluetooth, NFC or the like by using the sub-communication module 130, the controller 110 may determine that the external device is wirelessly connected to the device 100. Before the external device is connected to the device 100, the touch screen 190 of the device 100 may have been displaying another application being executed or a home screen, or may have been in an inactive state.

In step S508, the controller 110 extracts a list of customized applications which can be used with the connected external device. The customized applications may be referred to as second applications for convenience of description. The customized applications are applications, which can use the connected external device, when they are executed in the device 100. In an exemplary implementation, the customized applications are selected from the first applications. Therefore, the number of customized applications may be less than the number of first applications. Although it is assumed in FIG. 5 that the controller 110 performs the step of extracting a list of customized applications after the external device is connected to the device 100, the step of extracting a list of customized applications may be performed in advance before the external device is connected to the device 100.

Table 1 shows examples of external devices connectable to the device 100 and customized applications corresponding to the external devices.

TABLE 1

| | External device connected | |
|---|---|---|
| No. | to mobile device | List of customized applications |
| 1 | Earphone | Music 1, Music 2, Video 1, Video 2, |
| | | TV, Radio |
| 2 | External speaker | Music 1, Music 2, Music 3, Video 1, |
| | | Video 2, Video 3, TV, Radio |
| 3 | Cradle/dock | Music 1, Music 2, Music 3, Video 1, |
| | | Video 2, Video 3 |
| 4 | Multimedia player | Music 1, Music 2, Music 3, Video 1, |
| | | Video 2, TV, Radio |
| 5 | Mobile payment device | Payment 1, Payment 2 |
| 6 | Healthcare device (glucose | Heal 1, Heal 2, Exercise 1, |
| | meter, etc.) | Exercise 2 |
| 7 | Game manipulation device | Game 1, Game 2, Game 3, Game 4 |
| 8 | AP | Website 1, Website 2, Game 1, |
| | | Video 1 |

A list of customized applications, an example of which is shown in Table 1, may be determined by the controller 110. The controller 110 may initially provide the customized applications which are determined in advance by the manufacturer of the device 100. The controller 110 may also search information about the application name and metadata provided for each of the first applications, and determine applications having similar information as customized applications for the same external devices. The list of customized applications, in Table 1, may be determined by the controller 110. The controller 110 may set the applications directly selected by the user, as the customized applications.

In step S510, the controller 110 displays on the touch screen 190 one or multiple second icons for executing their associated extracted customized applications. For example, in the example of FIG. 6, if an earphone 10 is connected to the earphone connecting jack 167 while a home screen is being displayed on the touch screen 190 of the device 100, second icons 200 are displayed on the home screen. Upon determining that the earphone 10 is connected to the device 100, the controller 110 may display, on the home screen, icons Music 1 and Music 2 for executing applications providing music, icons Video 1 and Video 2 for executing applications providing video, an icon TV for executing an application providing TV broadcast, and an icon Radio for executing an application providing radio broadcast, as defined in Table 1. The icons may be displayed in order of Music 1, Music 2, Video 1, Video 2, TV and Radio according to their priority. Among the second icons 200, the top-priority icon Music 1 may be displayed in the upper-left corner of the home screen, while the lowest-priority icon Radio may be displayed in the lower-right corner of the home screen. The order of displaying the second icons 200 is subject to change, and this will be described in conjunction with another exemplary embodiment of the present invention. Although it is assumed in FIG. 6 that the second icons 200 are displayed on the home screen of the device 100, the second icons 200 may also be displayed on a quick panel of the device 100. The term ‘quick panel’ refers to a screen that is displayed on the touch screen 190 when the user drags down an upper part of the touch screen 190. The quick panel may be mainly used to set On/Off of WiFi, Bluetooth, GPS, speaker and the like, to indicate the status of the functions presently being executed in the device 100, or to indicate various notifications such as missed calls.

In step S512, the controller 110 determines whether one of the one or multiple second icons displayed on the touch screen 190 is touched.

If one of the displayed one or multiple second icons is touched, the controller 110 executes an application corresponding to the second icon selected by the touch and displays the execution results on the touch screen 190 in step S514. As a result, the user may quickly execute his or her desired application in the device 100 by touching one of the one or multiple second icons displayed on the touch screen 190. If two or more icons among the multiple second icons displayed on the touch screen 190 are touched, the controller 110 may simultaneously execute multiple applications corresponding to the touched two or more icons in the device 100.

On the other hand, in some cases, the user may desire to execute another application other than the customized applications (or second applications) corresponding to the displayed second icons. Therefore, if a predetermined time has elapsed while none of the one or multiple second icons is touched, or if the main menu key 191-4 displayed on the touch screen 190 is touched, the controller 110 displays on the touch screen 190 the first icons or the menu screen including the first applications shown in FIGS. 4A to 4E, in step S516. As a result, the user may directly select and execute his or her desired application(s) among the plurality of first applications included in the menu screen.

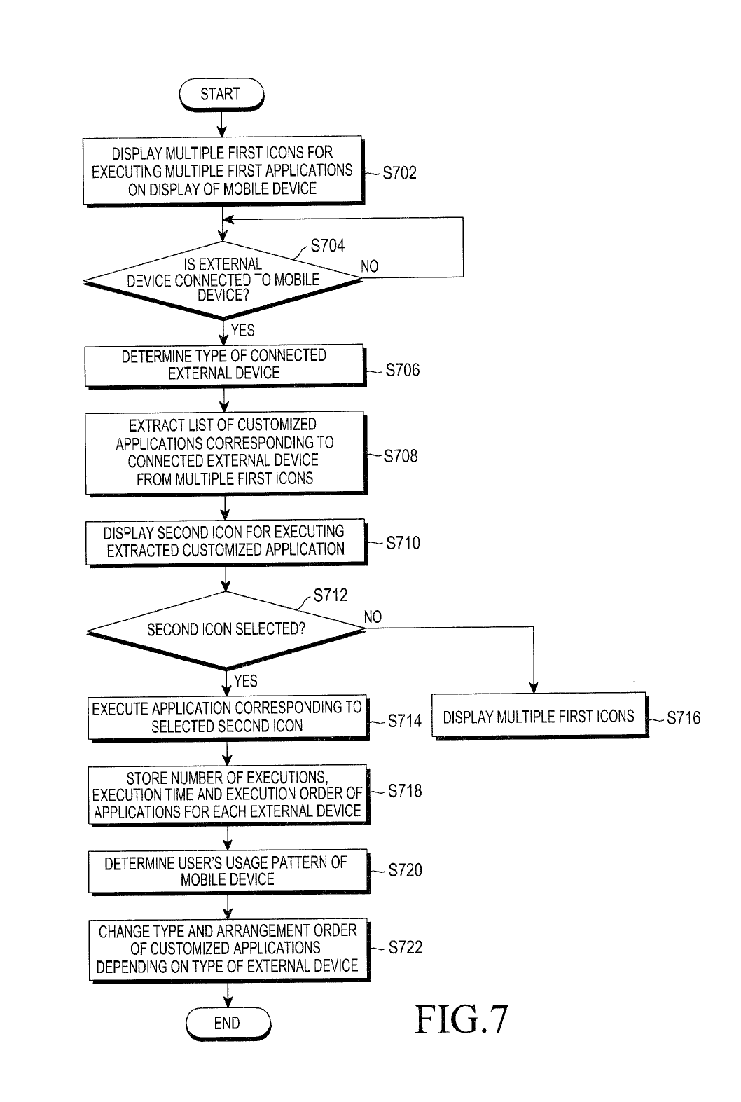

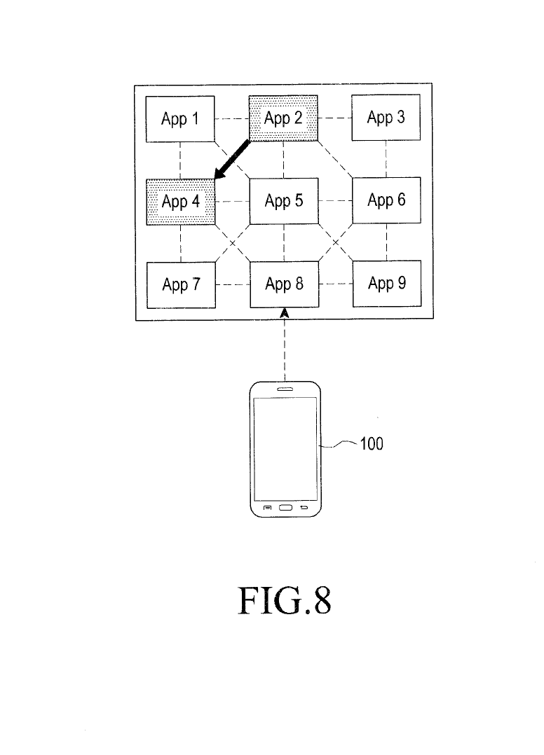

FIG. 7 is a schematic flowchart illustrating a method for providing a list of customized applications depending on the external device connected to a mobile device according to an exemplary embodiment of the present invention and FIG. 8 illustrates a recommendation order of applications depending on the external device connected to a mobile device according to an exemplary embodiment of the present invention.

Steps S702 to S716 in FIG. 7 are the same as steps S502 to S516 described with reference to FIG. 5. Therefore, steps S702 to S716 will be described in brief for convenience of description.

In step S702, the controller 110 displays a plurality of first shortcut keys for executing a plurality of first applications on the touch screen 190.

Subsequently, the controller 110 determines in step S704 whether an external device is connected to the device 100. If an external device is connected to the device 100, the controller 110 determines a type of the external device in step S706. Although steps S704 and S706 are separately described for convenience of description, the controller 110 may simultaneously recognize steps S704 and S706 as one operation.

In step S708, the controller 110 extracts a list of customized applications or second applications which can be used with the connected external device.

In step S710, the controller 110 displays on the touch screen 190 one or multiple second icons for executing the extracted customized applications.

The controller 110 determines in step S712 whether one of the one or multiple second icons displayed on the touch screen 190 is touched.

If it is determined in step S712 that one of the one or multiple second icons displayed on the touch screen 190 is touched, the controller 110 executes an application corresponding to the second icon selected by the touch and displays the execution results on the touch screen 190, in step S714.

On the other hand, if a predetermined time has elapsed while none of the one or multiple second icons is touched, or if the main menu key 191-4 displayed on the touch screen 190 is touched, the controller 110 displays on the touch screen 190 the first icons or the menu screen including the first applications shown in FIGS. 4A to 4E, in step S716.

Next, if the application (for example, a customized application or second application) corresponding to the selected second icon is executed in step S714, the controller 110 stores the execution information about the executed application in the storage unit 175 in step S718. In other words, the controller 110 stores in the storage unit 175 information about at least one of the number of executions, execution time and execution order of the application, which has been executed in the device 100 after the external device is connected to the device 100.

In step S720, the controller 110 determines the user's usage pattern of applications based on all or some of the stored execution information (for example, information about the number of executions, execution time and execution order) of applications.

An application, which has been frequently executed when a specific external device is connected to the device 100, may have a higher priority with respect to the specific external device, as the number of its executions is larger. For example, when an earphone 10 is connected to the device 100, if it is determined that a “Music 2” application has been most frequently used for a predetermined period (for example, recent one month, one week or one day), the controller 110 may set the highest priority for the “Music 2” application, determining that the user most prefers the “Music 2” application when the earphone 10 is connected to the device 100.

In addition, an application, which has been executed when a specific external device is connected to the device 100, may have a higher priority with respect to the specific external device as its execution time is longer, and may have a lower priority with respect to the specific external device as its execution time is shorter. For example, if a “Video 2” application has been executed for one hour or more while a media player is connected to the device 100, the controller 110 increases the priority of the “Video 2” application for the media player. However, if a “Video 1” application has been executed for a short time of a few seconds or less while the media player is connected to the device 100, the controller 110 may decrease or keep the priority of the “Video 1” application for the media player.

Further, the controller 110 may determine the type and display order of the applications included in a list of customized applications, by using the order in which the first applications are executed. FIG. 8 illustrates a recommendation order of applications App1˜App9 depending on the external device connected to a mobile device. Referring to FIG. 8, for example, if a “Music” application (for example, “App4”) providing music is frequently executed while an “e-Book” application (for example, “App2”) providing an e-book is presently being executed by the device 100, the controller 110 stores the execution order and frequency of the applications App2 and App4 in the storage unit 175. In this case, the controller 110 may determine that the user has the usage habits of simultaneously executing the “e-Book” application “App2” and the “Music” application “App4” by connecting the earphone 10 to the device 100. Therefore, the controller 110 first recommends the “Music” application “App4”, if the earphone 10 is connected to the device 100 while the “e-Book” application “App2” is being executed in the device 100.

In addition, if a new application not included in a customized application list is executed in the device 100 while a specific external device is connected to the device 100, the controller 110 may include the new application in the customized application list. For example, Table 1 described above includes applications for only Music 1, Music 2, Video 1, Video 2, TV and Radio as customized applications corresponding to an earphone. However, if applications for “Education 1” and “Education 2” are frequently executed while the earphone 10 is connected to the device 100, the controller 110 may include the applications for “Education 1” and “Education 2” in the customized application list. Further, the controller 110 may include in the customized application list the applications which have been executed only when a specific external device is connected to the device 100.

In step S722, the controller 110 may determine the type and arrangement order of customized applications depending on the type of the external device connected to the device 100 and the user's usage pattern, as described above. The controller 110 may change the type and order of customized applications, which are displayed on the touch screen 190 in step S710, depending on the type and arrangement order of customized applications, which are determined depending on the type of the external device and the usage habits. Specifically, Table 2 below defines a customized application list in which a user's usage pattern is reflected depending on the type of an external device connected to the mobile device. When Table 2 is compared with Table 1, it is noted that the customized application list is changed. For example, in Table 1, the list is made in order of customized applications for Music 1, Music 2, Video 1, Video 2, TV and Radio corresponding to an earphone. However, referring to Table 2, as to the customized applications for an earphone, the list is changed such that the “Music 2” application is displayed in the first place since it has the highest priority, and the “Video 1” application is displayed in the second place. In addition, it is noted that applications for “Education 1” and “Education 2” providing educational content are added in Table 2 as a customized application list corresponding to an earphone. Furthermore, the display order of customized applications for an external speaker is also changed in order of “Music 3”, “Music 2”, “Music 1”, “Video 3”, “Video 2”, and “Video 1”, and “Education 1” and “Game 1” applications are newly included in the customized application list.

TABLE 2

| | External device connected | Customized application list based on |
|---|---|---|
| No. | to mobile device | user's usage pattern |
| 1 | Earphone | Music 2, Video 1, Music 1, Video 2, |
| | | DMB, Radio, Education 1, |
| | | Education 2 |
| 2 | External speaker | Music 3, Music 2, Music 1, Video 3, |
| | | Video 2, Video 1, Education 1, |
| | | Game 1 |
| 3 | Cradle/dock | Music 1, Music 2, Music 3, Video 1, |
| | | Video 2, Video 3 |
| 4 | Multimedia player | Music 1, Music 2, Music 3, Video 1, |
| | | Video 2, TV, Radio |
| 5 | Mobile payment device | Payment 1, Payment 2 |
| 6 | Healthcare device (glucose | Health 1, Health 2, Exercise 1, |
| | meter, etc.) | Exercise 2 |
| 7 | Game manipulation device | Game 1, Game 2, Game 3, Game 4 |
| 8 | AP | Website 1, Website 2, Game 1, |
| | | Video 1 |

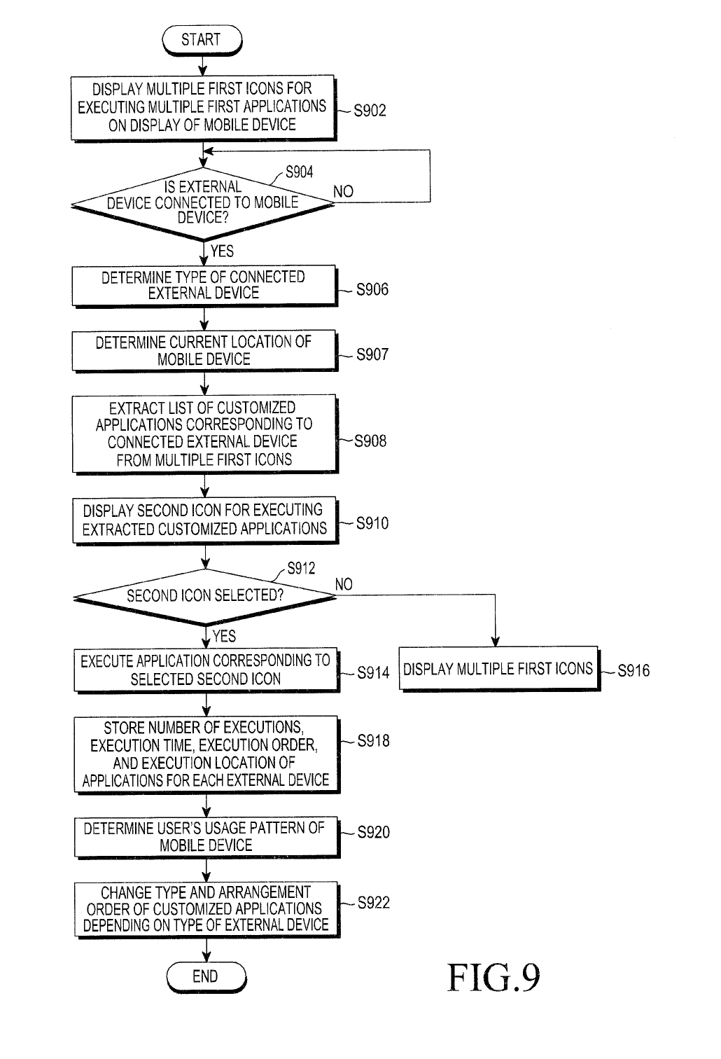

FIG. 9 is a schematic flowchart illustrating a method for providing a list of customized applications depending on the external device connected to a mobile device according to an exemplary embodiment of the present invention.

Steps S902 to S916 in FIG. 9 are the same as steps S502 to S516 in FIG. 5, except for step S907. Therefore, steps S902 to S916 will be described in brief for convenience of description.

First, the controller 110 displays a plurality of first shortcut keys for executing a plurality of first applications on the touch screen 190 in step S902.

Subsequently, the controller 110 determines in step S904 whether an external device is connected to the device 100. If an external device is connected to the device 100, the controller 110 determines a type of the connected external device in step S906. Although steps S904 and S906 are separately described for convenience of description, the controller 110 may recognize steps S904 and S906 as one operation.

The controller 110 determines the current location of the device 100 in step S907. The controller 110 may determine the current location of the device 100 using at least one of location information calculated by the GPS module 155, altitude information provided from the sensor module 170, and information about a wireless AP that the device 100 accesses by means of the sub-communication module 130.

In step S908, the controller 110 extracts a list of customized applications or second applications which can be used with the connected external device. The controller 110 may extract the list of customized applications taking into account the current location information of the device 100, which is determined in step S907. For example, the controller 110 may provide a list of different customized applications depending on whether the device 100 is presently located in the user's home or user's office.

In step S910, the controller 110 displays on the touch screen 190 one or multiple second icons for executing the extracted customized applications.

In step S912, the controller 110 determines whether one of the one or multiple second icons displayed on the touch screen 190 is touched.

If it is determined in step S912 that one of the one or multiple second icons is touched, the controller 110 executes an application corresponding to the second icon selected by the touch and displays the execution results on the touch screen 190 in step S914.

If a predetermined time has elapsed while none of the one or multiple second icons is touched, or if the main menu key 191-4 displayed on the touch screen 190 is touched, the controller 110 displays on the touch screen 190 the first icons or the menu screen including the first applications shown in FIGS. 4A to 4E, in step S916.

Next, if an application (for example, a customized application or a second application) corresponding to the second icon selected in step S912, the controller 110 stores the execution information about the executed application in the storage unit 175 in step S918. More specifically, in step S918, the controller 110 stores in the storage unit 175 information about at least one of the number of executions, execution time, execution order and execution location of the application, which has been executed in the device 100 after the external device is connected to the device 100. The ‘execution location’ refers to the place where the application is executed, and may include, for example, a user's home, a user's office, school, or the like.

In step S920, the controller 110 determines the user's usage pattern of applications based on all or some of the stored execution information (for example, information about the number of executions, execution time, execution order and execution location) of applications.

In step S922, the controller 110 may determine the type and arrangement order of customized applications depending on the type of the external device connected to the device 100, the user's usage pattern, the current location of the device 100, and the like. The controller 110 may change the type and order of the customized applications, which are displayed on the touch screen 190 in step S910, depending on the type of the external device, the user's usage pattern, and the type and arrangement order of the customized applications, which are determined depending on the current location of the device 100. More specifically, Table 3 below defines a customized application list in which a user's usage pattern is reflected depending on the type of an external device connected to the mobile device and the location of the mobile device. When Table 3 is compared with Tables 1 and 2, it is noted that the customized application list is changed. For example, referring to Table 3, the customized application list for an earphone may be different depending on the place (school, home, office, and the like). The controller 110 may determine the places where the external device is connected to the device 100 and applications are executed, by using location information such as GPS information and altitude information of the device 100. Referring to Table 3, the places are divided into Place 1, Place 2 and Place 3, which may correspond to school, user's home and user's office, respectively. If the device 100 is located in Place 1 (school), the customized application list may include applications for “Music 2”, “Video 1”, “Music 1”, “Video 2”, “DMB”, “Radio”, “Education 1”, and “Education 2”. If the device 100 is located in Place 2 (user's home), the customized application list may include applications for “Music 2”, “Game 1”, “Game 2”, “Video 1”, “Music 1”, and “Education 1”. If the device 100 is located in Place 3 (office), the customized application list may include applications for “Music 2” and “Music 1”.

TABLE 3

| | | | Customized application |
|---|---|---|---|
| | External | Execution | list based on user's |
| No. | device | location | usage pattern and execution location |
| 1 | Earphone | Place 1 | Music 2, Video 1, Music 1, Video 2, |
| | | | DMB, Radio, Education 1, Education 2 |
| | | Place 2 | Music 2, Game 1, Game 2, Video 1, |
| | | | Music 1, Education 1 |
| | | Place 3 | Music 2, Music 1 |
| | | . . . | . . . |

If the customized application list set as above is determined, the controller 110 may provide a different customized application list depending on the type of the external device connected to the device 100, the user's usage pattern, and the location of the device 100. The controller 110 may also provide a different customized application list depending on the current time. For example, the customized application list that the controller 110 provides when a specific external device (for example, an earphone) is connected to the device 100 in the morning, may be set different from the customized application list that the controller 110 provides when the external device is connected to the device 100 in the afternoon. The controller 110 may also provide a different customized application list depending on the battery level of the device 100.

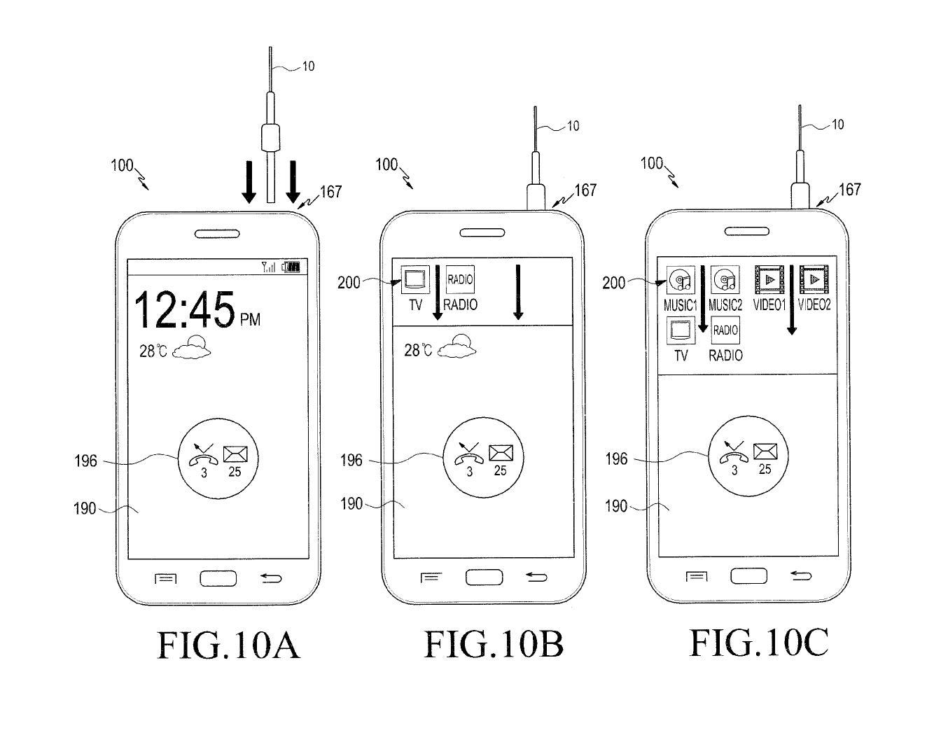

FIGS. 10A to 10C illustrate a list of customized applications displayed on a display according to an exemplary embodiment of the present invention.

First, FIG. 10A illustrates a lock screen, which is displayed on the touch screen 190 of the device 100 before the earphone 10 is inserted into the earphone connecting jack 167. The user may set in advance a password, a lock pattern, a face recognition lock feature or the like on the lock screen so that other people may not use the device 100. If no password is set for the lock screen, anyone can unlock the lock screen by flicking the lock screen. The number of missed calls and received messages may be displayed on the lock screen as shown by reference numeral 196. Conventionally, the user needs to enter a correct password on the lock screen to unlock the lock screen and enjoy a variety of applications installed in the device 100.

Next, FIG. 10B illustrates the situation in which, after the earphone 10 is inserted into the earphone connecting jack 167 of the device 100, second icons 200, which can execute customized applications in the device 100 according to exemplary embodiments of the present invention, begin to be displayed.

FIG. 10C illustrates the situation in which all of the second icons 200 have been displayed on the lock screen of the touch screen 190.

As illustrated in FIGS. 10A to 10C, if the earphone 10 is inserted into the earphone connecting jack 167 located on the top side of the device 100, the second icons 200 may be displayed, gradually sliding down from the top of the touch screen 190, which is close to the position where the earphone 10 is inserted. In this case, in the area on the touch screen 190, which is close to the inserted earphone 10, the second icons 200 are displayed, sliding in the same direction as the insertion direction of the earphone 10, so the user may be intuitively aware that the second icons 200 correspond to the applications that he or she can enjoy with the earphone 10.

In an exemplary embodiment of the present invention, if any one of the second icons 200 is touched while the second icons 200 are displayed on the lock screen, the controller 110 may execute an application corresponding to the second icon selected by the touch and display the execution results on the touch screen 190, without a separate process of unlocking the lock screen. In addition, if any one of the second icons 200 is touched while the second icons 200 are displayed on the lock screen, the controller 110 may not execute the application corresponding to the second icon selected by the touch unless the process of unlocking the lock screen is completed.

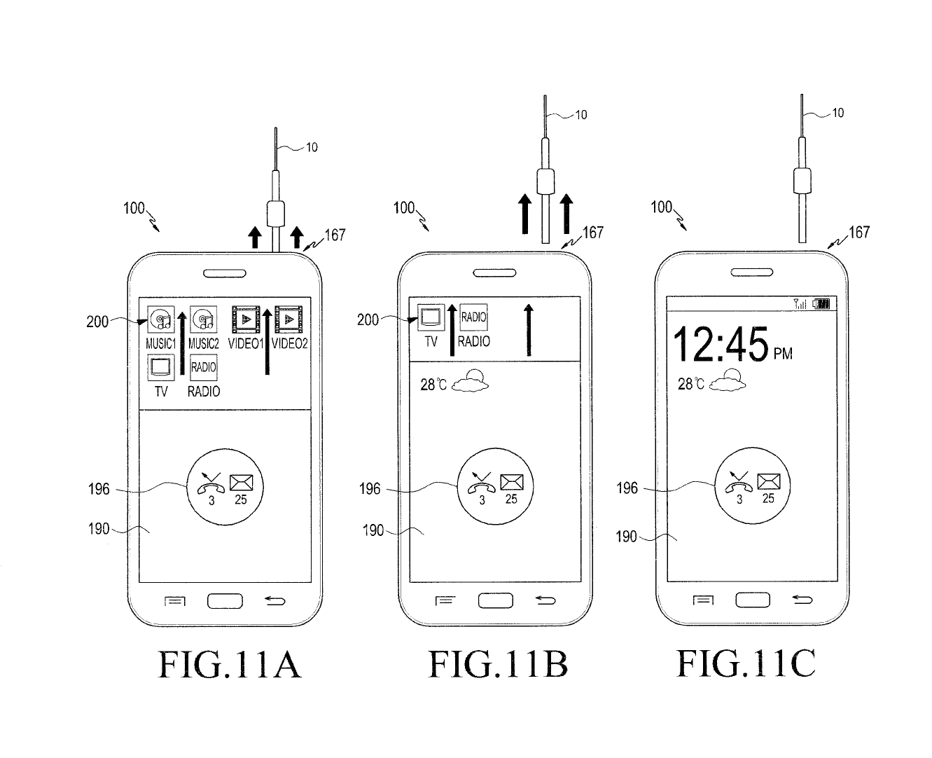

FIGS. 11A to 11C illustrate a list of customized applications disappearing from a display according to an exemplary embodiment of the present invention.

Referring to FIGS. 11A to 11C, if the earphone 10 is detached from the earphone connecting jack 167 located on the top side of the device 100, the controller 110 may control the second icons 200 to disappear from the touch screen 190, sliding in the same direction as the detachment direction of the earphone 10. Also, as illustrated in FIGS. 10A to 10C, the number of missed calls and received messages may be displayed on the lock screen as shown by reference numeral 196.

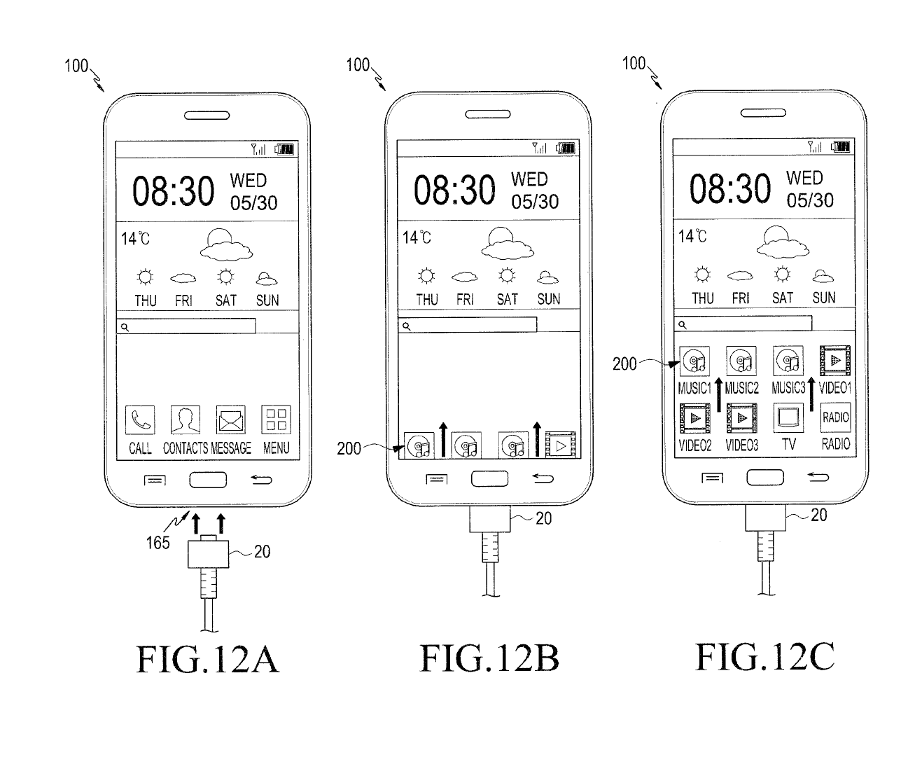

FIGS. 12A to 12C illustrate a list of customized applications displayed on a display according to an exemplary embodiment of the present invention.

Referring to FIGS. 12A to 12C, if a connector 20 of an external device is inserted into the connector 165 of the device 100, customized applications are displayed on the touch screen 190, sliding up in the insertion direction of the connector 20.

First, FIG. 12A illustrates a home screen, which is displayed on the touch screen 190 of the device 100 before the connector 20 of the external device is inserted into the connector 165 of the device 100.

Next, FIG. 12B illustrates the situation in which, after the connector 20 of the external device is inserted into the connector 165 formed in the bottom of the device 100, second icons 200, which can execute customized applications in the device 100 according to exemplary embodiments of the present invention, begin to be displayed.

FIG. 12C illustrates the situation in which all of the second icons 200 have been displayed on the home screen of the touch screen 190.

As illustrated in FIGS. 12A to 12C, if the connector 20 of the external device is inserted into the connector 165 located on the bottom side of the device 100, the second icons 200 may be displayed, gradually sliding up from the bottom of the touch screen 190, which is close to the position where the connector 20 of the external device is inserted. In this case, in the area on the touch screen 190, which is close to the inserted external device, the second icons 200 are displayed, sliding in the same direction as the insertion direction of the external device, so the user may be intuitively aware that the second icons 200 correspond to the applications that he or she can enjoy with the external device.

The connector 20 of the external device is an interface for connecting the external device to the device 100 by wire, and may be formed to be fixed to the external device, or to be detachable from the external device.

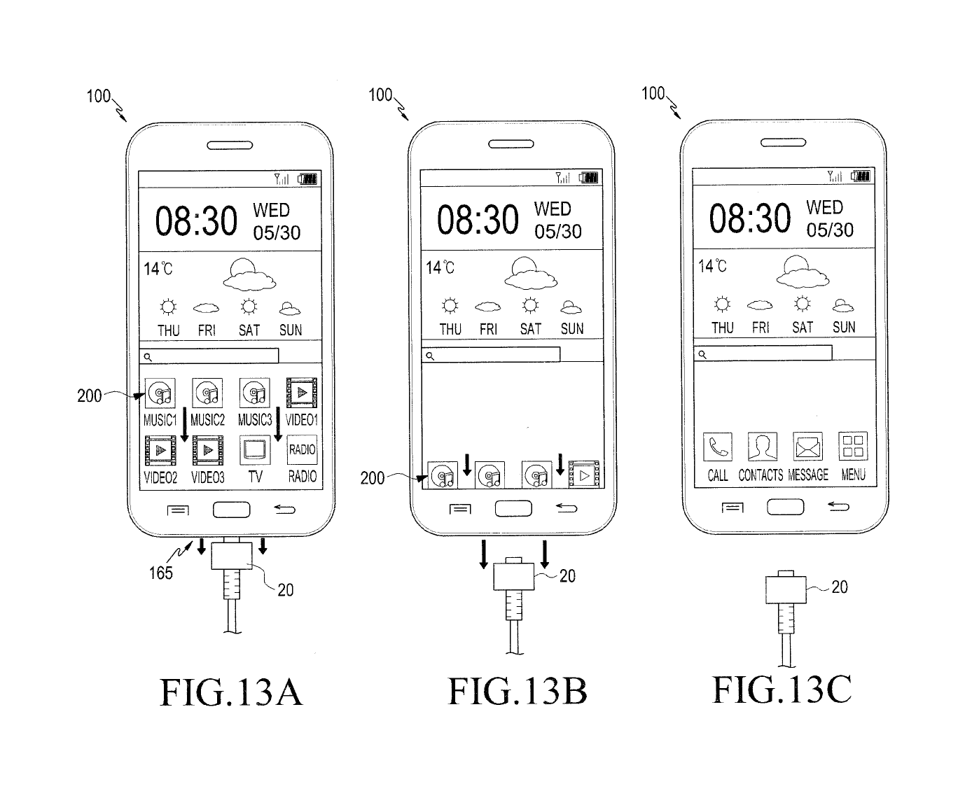

FIGS. 13A to 13C illustrate a list of customized applications disappearing from a display according to an exemplary embodiment of the present invention.

Referring to FIGS. 13A to 13C, if the connector 20 of the external device is detached from the connector 165 located on the bottom side of the device 100, the controller 110 may control the second icons 200 to disappear from the touch screen 190, sliding in the same direction as the detachment direction of the connector 20 of the external device.

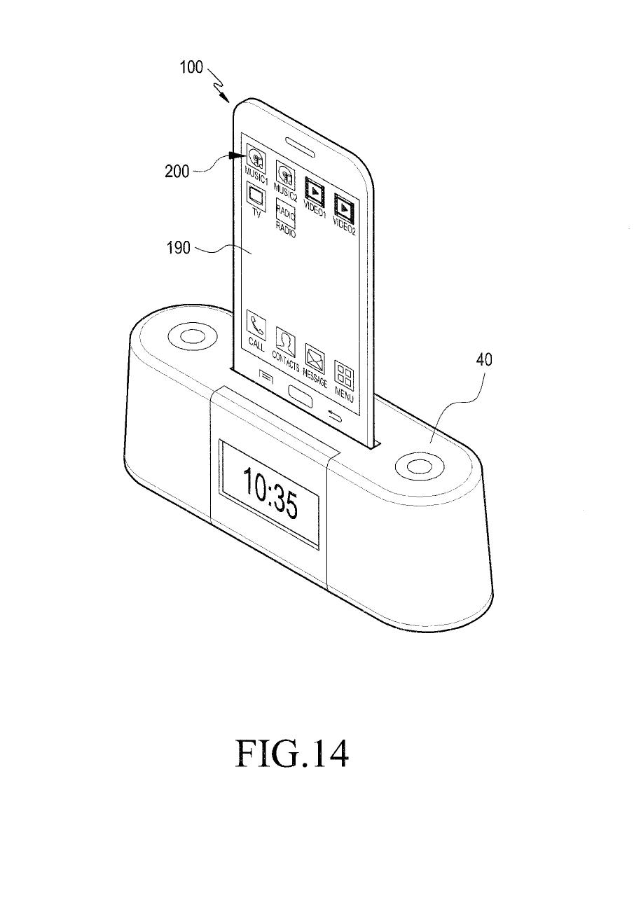

FIG. 14 illustrates a mobile device connected to a multimedia player according to an exemplary embodiment of the present invention.

Referring to FIG. 14, the device 100 is inserted into a receiving portion formed in a multimedia player 40, and the connector 165 of the device 100 and a connector (not shown) of the multimedia player 40 are connected to each other by wire. As illustrated in FIG. 14, a customized application list is displayed on the touch screen 190 of the device 100. The customized application list includes “Music 1”, “Music 2”, “Video 1”, “Video 2”, “TV”, and “Radio” applications, which are displayed as second icons 200.

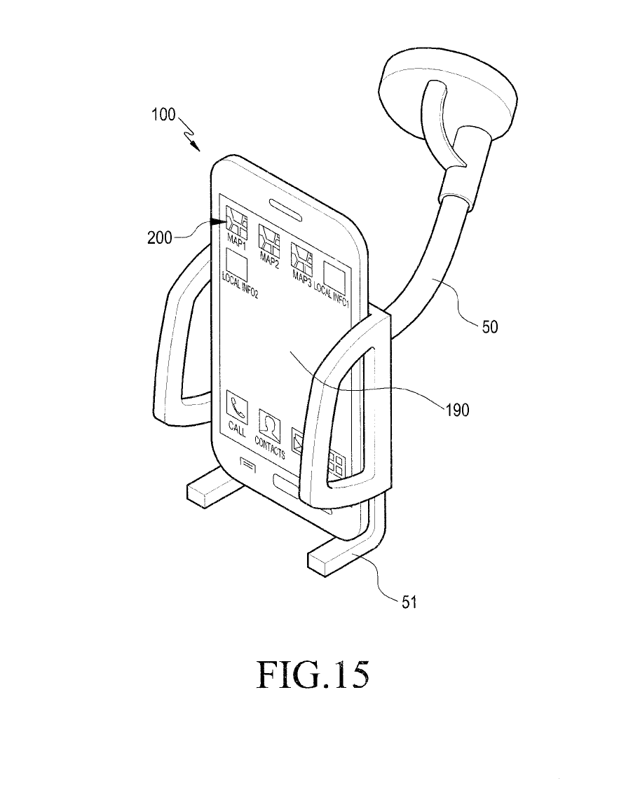

FIG. 15 illustrates a mobile device connected to a car navigation device according to an exemplary embodiment of the present invention.

Referring to FIG. 15, the device 100 is mounted in a support structure 51 of a navigation device 50. The connector 165 of the device 100 and a connector (not shown) of the navigation device 50 may be connected to each other by wire. Also, the sub-communication module 130 of the device 100 and the navigation device 50 may be wirelessly connected to each other by wireless short-range communication. In this case, the navigation device 50 may include a memory for storing identification information of the navigation device 50, a communication interface for wireless short-range communication with the sub-communication module 130, and a processor for controlling access to the device 100 by wireless short-range communication. Referring to FIG. 15, a customized application list is displayed on the touch screen 190 of the device 100. The customized application list includes “Map 1”, “Map 2” and “Map 3” applications providing map data and information about the vehicle's driving directions, and “Local Info 1” and “Local Info 2” applications providing information about the buildings, shops, attractions and the like around the device 100, and these applications are displayed as second icons 200.

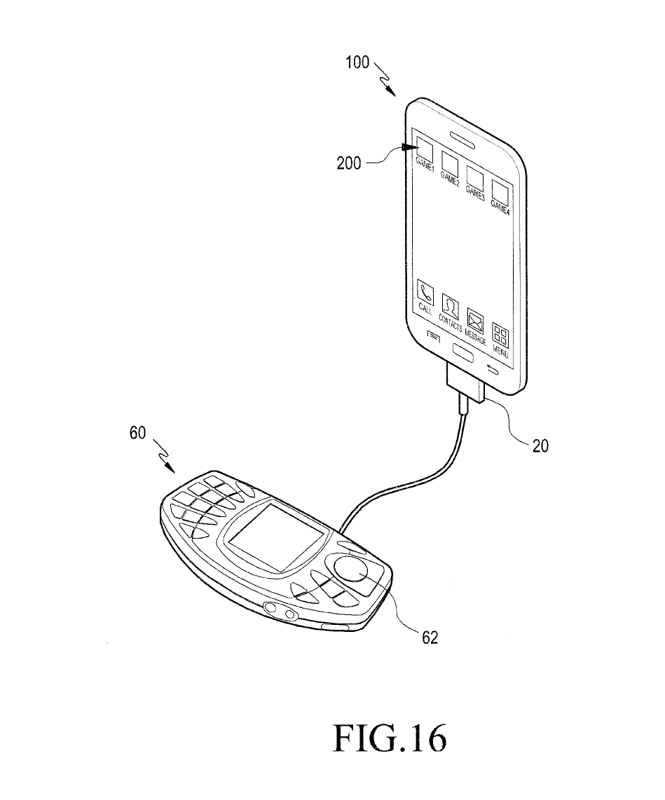

FIG. 16 illustrates a mobile device connected to a game manipulation device according to an exemplary embodiment of the present invention.

Referring to FIG. 16, a game manipulation device 60 has a plurality of keys 62 such as direction keys and selection keys, which are formed to manipulate game applications executable in the device 100. The game manipulation device 60 is connected to the device 100 through a connector 20 of an external device. A customized application list is displayed on the touch screen 190 of the device 100. The customized application list includes “Game 1”, “Game 2”, “Game 3” and “Game 4” applications providing a variety of video games, and they are displayed as second icons 200.

Methods according to exemplary embodiments of the present invention may be implemented in the form of program commands executable by means of a variety of computers, and recorded in computer-readable media. The computer-readable media may include program commands, data files, data structure and the like individually or in combination. The program commands recorded in the media may be program commands specifically designed and configured for the present invention, or may be program commands known to those of ordinary skill in the field of computer software.

As is apparent from the foregoing description, if an external device is connected to a mobile device, exemplary embodiments of the present invention allow a user to quickly find shortcut keys for executing applications that can be used in the mobile device with the connected external device, and to easily execute his or her desired applications using the shortcut keys.

In addition, if an external device is connected to a mobile device, the mobile device proposed by exemplary embodiments of the present invention may provide a list of customized applications frequently used by its user, depending on the user's usage pattern, so the user may quickly and easily execute his or her frequently used applications.

Besides, if an external device is connected to a mobile device, the mobile device proposed by exemplary embodiments of the present invention may provide a list of customized applications frequently used by its user, depending on the user's location, so the user may quickly and easily execute his or her frequently used applications.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for providing an application list depending on an external device connected to a mobile device, the method comprising:
displaying a plurality of first shortcut keys, for executing a plurality of first applications, on a display of the mobile device;
determining whether the mobile device is connected to an external device;
if the mobile device is connected to the external device, displaying on the display at least one second shortcut key for executing at least one second application, with which the external device can be used, among the plurality of first applications;
determining whether the second shortcut key displayed on the display is selected;
if the second shortcut key is selected, executing a second application corresponding to the selected second shortcut key in the mobile device; and
displaying execution results of the second application on the display.

2. The method of claim 1, wherein the at least one second shortcut key is selected from the plurality of first shortcut keys, and the number of the at least one second shortcut key is less than the number of the plurality of first shortcut keys.

3. The method of claim 1, wherein the at least one second shortcut key is selected from the plurality of first shortcut keys based on information about at least one of a number of executions, an execution time and an execution order of the plurality of first applications, which have been executed while the external device is connected to the mobile device.

4. The method of claim 1, wherein the at least one second shortcut key is selected from the plurality of first shortcut keys, and includes different first shortcut keys which are selected depending on at least one of the current location of the mobile device and the current time.

5. The method of claim 1, wherein the at least one second shortcut key is selected from the plurality of first shortcut keys based on information about at least one of a number of executions, an execution time and an execution order of the plurality of first applications, which have been executed while the external device is connected to the mobile device, and
wherein the at least one second shortcut key includes different first shortcut keys which are selected depending on at least one of the current location of the mobile device and the current time.

6. The method of claim 1, wherein the external device comprises an earphone that is connected to an earphone connecting jack of the mobile device, and the second shortcut key is displayed on the display to slide along a direction in which the earphone is inserted into the earphone connecting jack.

7. The method of claim 1, wherein the external device includes an external device connector that is connected to a connector of the mobile device, and the second shortcut key is displayed on the display to slide along a direction in which the external device connector is inserted into the connector of the mobile device.

8. The method of claim 1, wherein the second shortcut key is displayed on the display to slide along a direction in which the external device is inserted into the mobile device, and
wherein the second shortcut key disappears from the display to slide along a direction in which the external device is detached from the mobile device.

9. The method of claim 1, wherein the external device is wirelessly connected to the mobile device by wireless short-range communication.

10. The method of claim 1, wherein the at least one second shortcut key is displayed on a lock screen of the mobile device.

11. The method of claim 1, wherein at least some of the at least one second application are downloaded in the mobile device from an application sales website on the Internet.

12. An apparatus for providing an application list depending on an external device connected to a mobile device, the apparatus comprising:
a display for displaying a plurality of first shortcut keys for executing a plurality of first applications;
an external device connector to which an external device is connected by wire or wirelessly; and
a controller for displaying on the display at least one second shortcut key for executing at least one second application, with which the external device can be used, among the plurality of first applications, if the external device is connected to the external device connector.

13. The apparatus of claim 12, wherein if the second shortcut key displayed on the display is selected, the controller executes an application corresponding to the selected second shortcut key in the mobile device, and displays the execution results of the second application on the display.

14. The apparatus of claim 12, wherein the at least one second shortcut key is selected from the plurality of first shortcut keys, and the number of the at least one second shortcut key is less than the number of the plurality of first shortcut keys.

15. The apparatus of claim 12, wherein the at least one second shortcut key is selected from the plurality of first shortcut keys based on information about at least one of a number of executions, an execution time and an execution order of the plurality of first applications, which have been executed while the external device is connected to the mobile device.

16. The apparatus of claim 12, wherein the at least one second shortcut key is selected from the plurality of first shortcut keys, and includes different first shortcut keys which are selected depending on at least one of the current location of the mobile device and the current time.

17. The apparatus of claim 12, wherein the at least one second shortcut key is selected from the plurality of first shortcut keys based on information about at least one of a number of executions, an execution time and an execution order of the plurality of first applications, which have been executed while the external device is connected to the mobile device, and
wherein the at least one second shortcut key includes different first shortcut keys which are selected depending on at least one of the current location of the mobile device and the current time.

18. The apparatus of claim 12, wherein the external device connector comprises an earphone connecting jack, the external device is an earphone that is connected to an earphone connecting jack of the mobile device, and the second shortcut key is displayed on the display to slide along a direction in which the earphone is inserted into the earphone connecting jack.

19. The apparatus of claim 12, wherein the external device connector is a connector formed in the mobile device, the external device includes an external device connector that is connected to a connector of the mobile device, and the second shortcut key is displayed on the display to slide along a direction in which the external device connector is inserted into the connector for the mobile device.

20. The apparatus of claim 12, wherein the second shortcut key is displayed on the display to slide along a direction in which the external device is inserted into the mobile device, and
wherein the second shortcut key disappears from the display to slide along a direction in which the external device is detached from the mobile device.

21. The apparatus of claim 12, wherein the external device connector comprises a sub-communication module capable of wireless short-range communication, and the external device is wirelessly connected to the sub-communication module of the mobile device by the wireless short-range communication.

22. The apparatus of claim 12, wherein the at least one second shortcut key is displayed on a lock screen of the mobile device.

23. The apparatus of claim 12, wherein at least some of the at least one second application are downloaded in the mobile device from an application sales website on the Internet.

24. The apparatus of claim 12, wherein, if no second shortcut key displayed on the display is selected, the controller displays again on the display the plurality of first shortcut keys for executing the plurality of first applications.
